(19) United States
(12) Patent Application Publication
(10) Pub. No.: US 2006/0245368 A1
(43) Pub. Date: Nov. 2, 2006

(54) Verification of a communication path between networks

(75) Inventors: Gregory C. Ladden, Vernon Hills, IL (US); Mohamad A. Dawood, Barrington, IL (US); James S. Marin, Murphy, TX (US); Lewis J. Milton, Glencoe, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC.

(21) Appl. No.: 11/406,481

(22) Filed: Apr. 18, 2006

Related U.S. Application Data
(60) Provisional application No. 60/676,097, filed on Apr. 29, 2005.

(51) Int. Cl. H04J 3/14

(52) U.S. Cl. 370/248; 370/249

(57) ABSTRACT

A system and method for verification of a communication path between a first and a second network by turning on and off a loop back mode. Firstly, verification begins by requesting verification of a communication path by the first network. The second network then acknowledges the verification request and places the communication path in a loop back mode. The first network sends a verification signal over the communication path, which is returned by the second network over the communication path. The second network then terminates the loop back mode. Timers can be included for the acknowledgment and termination steps to ensure the temporary nature of the loop back mode.

### FIELD OF THE INVENTION

The present invention relates generally to the field of communication systems, and more particularly, to a verification of a communication path between networks.

### BACKGROUND OF THE INVENTION

Access systems such as standardized by 3GPP2 for cdma2000, 3GPP for the Universal Mobile Telephone System (UMTS), and IEEE for the 802 series standards support concurrent services functionality over various bearer paths. As a result, there can be problems with conflicting demands for existing communication capacity on a bearer path (the physical layer that carries the bearer circuit or packet information), which may be improperly provisioned or may be faulty. Moreover, there is considerable operating expense for cellular operators to diagnose faulty trunks between communication entities such as a Core Network and a base station (BS). The BS may be any radio access network (RAN). Communication (bearer) path tests are therefore useful between communication entities to assure that a transport network is available and has continuity before operational traffic is placed on the bearer path. Bearer path tests have been performed for some links of cellular and wireline networks. However, such tests can cause an interruption of service, which is inconvenient for users. Moreover, such bearer path tests are not currently specified between the mobile switching center (MSC) core network and the radio access network (RAN) of base stations. More specifically, the tests are not currently specified in the 3GPP2 cdma2000 network between either the packet or circuit core networks and the RAN. The tests are also not specified in the 3GPP (GSM & UMTS) Standards. A particular problem to be solved is to perform bearer path verification during the normal call setup procedure for both circuit and packet bearer paths. The existing MSC/BS standards do not support this bearer path testing.

A solution for continuity testing between 4-wire MSC circuits has been provided in ITU-T Q.724 Specifications of Signalling System No. 7, Section 7, “Continuity-check for 4-wire speech circuits,” 1989. In addition, bearer path availability testing between Inter-MSC links has been provided in 3GPP2 N.S0005-0 3GPP2, Cellular Radiotelecommunications Intersystem Operations, Section 6, “InterMSC Trunk Testing,” Version 1.0. (also known as ANSI 41). However, neither of these standards defines the testing of the bearer path between the Core Network and the RAN. Further, neither of these standards provides a testing mode that can be switched on and off in a short period of time to provide bearer path verification that is transparent to a user.

What is needed is a method for a bearer path verification between an circuit or packet core network and RAN. It would also be of benefit to provide a signaling technique for bearer path verification that would be transparent to a user so as to prevent user inconvenience.

### BRIEF DESCRIPTION OF THE DRAWINGS

The features of the present invention, which are believed to be novel, are set forth with particularity in the appended claims. The invention, together with further objects and advantages thereof, may best be understood by making reference to the following description, taken in conjunction with the accompanying drawings, in the several figures of which like reference numerals identify identical elements, wherein:

FIG. 1 shows a simplified block diagram for a circuit-switched system, in accordance with one embodiment of the present invention;

FIG. 2 shows a simplified block diagram for a packet-switched system, in accordance with one embodiment of the present invention; and

FIG. 3 shows a simplified block diagram for a Voice over Internet Protocol (VoIP) system, in accordance with one embodiment of the present invention;

FIG. 4 shows a simplified call flow diagram of a first embodiment of communication path verification for the system of FIG. 1;

FIG. 5 shows a simplified call flow diagram of a second embodiment of communication path verification for the system of FIG. 1;

FIG. 6 shows a simplified call flow diagram of a third embodiment of communication path verification for the system of FIG. 1;

FIG. 7 shows a simplified call flow diagram of a first embodiment of communication path verification for the system of FIG. 2;

FIG. 8 shows a simplified call flow diagram of a second embodiment of communication path verification for the system of FIG. 2;

FIG. 9 shows a simplified call flow diagram of a third embodiment of communication path verification for the system of FIG. 2;

FIG. 10 shows a simplified call flow diagram of a fourth embodiment of communication path verification for the system of FIG. 2;

FIG. 11 shows a simplified call flow diagram of a communication path verification for a handoff for the system of FIG. 1;

FIG. 12 shows a simplified call flow diagram of a communication path verification for a handoff for the system of FIG. 2;

FIG. 13 shows a generic call flow diagram, in accordance with the present invention; and

FIG. 14 shows a binary-coded Information Element (IE) for requesting and acknowledging loop back mode, in accordance with the present invention.

### DETAILED DESCRIPTION OF THE PREFERRED EMBODIMENT

The present invention gives cellular operators a technique to verify the communication path between networks, and in particular the bearer path on a per circuit basis between the Core Network and BS prior to establishing a cellular call. In particular, the present invention provides a method of signaling, the time interval for communication path verification, and the method to perform communication path verification between networks. Specifically, the present invention provides a technique to turn on and off loop-back in a bearer path between a RAN and a core network to provide bearer path verification. As such, the present invention is applicable to 3GPP, 3GPP2 and UMTS systems.

For example, the present invention can use an ANSI-41 specified MSC/VLR, to initiate the bearer verification request commands to direct a CDMA base station (BS) to provide a time-limited loop back mode. Any BS and MSC compliant with the TIA-2001 CDMA standard can be used to implement the present invention, such as equipment available from Motorola, Inc., Schaumburg, Ill. In the preferred embodiment of the present invention, the method is distributed between a system of the serving MSC and the BS of the infrastructure. In the MSC, the invention can be implemented by an Electronic Mobile Exchange (EMX), for example. In the BS, the invention can be implemented by a Compaq Puma computer for signaling, for example. In the BS, the invention can be implemented by a digital signal processor for the bearer path, for example. It should be recognized by one of ordinary skill in the art that the method may be implemented centrally within the infrastructure using any available equipment suited for the purpose. For example, the present invention can be used between a MSC and a BS, or it can be used in VoIP situations, as will be detailed below. It should be noted that the use of the term MSC herein can apply to both circuit-switched mobile switching centers (MSC) and packet-switched Mobile Switching Center Emulation (MSCe). In the case of VoIP, the access terminal (AT) or mobile station (MS) provides the loop back functionality instead of the BS.

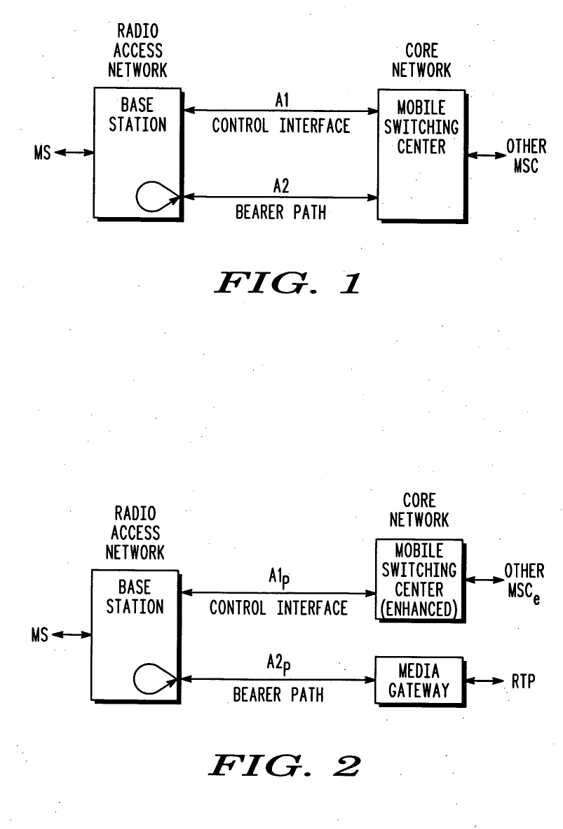

FIG. 1 shows a simplified embodiment of a circuit-switched communication path verification to ensure reliable delivery of a message that terminates at a mobile station (MS). This circuit bearer path test is performed over the A2 (or A5 which is circuit data bearer path between the MSC and BS and is controlled by the A1 signaling interface.) interface (known in the art) between the MSC and BS. The A1 interface (also known in the art) is used to signal the BS in order to place the BS Bearer A2 interface in loop back so that the MSC can transmit a verification signal (such as a tone) over the A2 interface to the BS, which then echoes the signal over the A2 interface back to the MSC, which then quantitatively measures the signal in order to verify the A2 interface continuity. In this case, the loop back is instantiated at the BS as shown and the MSC is in control of the communication path verification test.

However, it should be noted that loop back can also be instantiated at the MSC (not shown) in the case of calls originating at a MS by incorporating a minor modification to the call flow instructions to enable the BS to be in control of the communication path verification test. In this case, to ensure reliable delivery of a message that originates at a mobile station (MS), the circuit bearer path test is performed over the A2 (or A5) interface between the BS and MSC. The A1 interface is used to signal the MSC in order to place the MSC bearer A2 interface in loop back so that the BS can transmit a signal (such as a tone) over the A2 interface to the MSC, which then echoes the signal back to the BS, which then quantitatively measure the tone in order to verify the A2 interface continuity.

In either of the above two examples, the present invention toggles a circuit-switched bearer path into and out of loop back for testing between the networks. The toggling is time-limited to prevent any noticeable interruption of service, and some of the communication operations can be performed in the background of the system so as to further reduce any noticeable interruption of service. The present invention includes new A1/A2 procedures including new A1 messages over the A1 Interface for the purposes of bearer path verification via loop back, as will be detailed below.

FIG. 2 shows a simplified embodiment of a packet-switched communication (Bearer) path verification to ensure reliable delivery of a message that terminates at a mobile station (MS). The packet bearer path test is performed over the A2p interface (known in the art) between a media gateway (MGW) and BS. The MGW communicates with the MSCe to ensure that packets are properly addressed. The A1p interface (also known in the art) is used to signal from the MSCe to the BS in order to place the BS Bearer A2p interface in loop back so that the MGW can transmit a verification signal message (such as a tone event in place of an encoded tone) over the A2p interface to the BS, which then echoes the signal back over the A2p interface to the MSCe, which then quantitatively measures the verification signal message in order to verify the A2p interface continuity. In this case, the loop back is instantiated at the BS as shown and the MSCe is in control of the communication path verification test.

However, it should be noted that loop back can also be instantiated at the MGW (not shown) in the case of calls originating at a MS by incorporating a minor modification to the call flow instructions to enable the BS to be in control of the bearer path verification test. In this case, to ensure reliable delivery of a message that originates at a mobile station (MS), the packet bearer path test is performed over the A2p interface between the BS and MGW. The MSCe communicates with the MGW to ensure that packets are properly addressed. The A1p interface is used to signal from the BS to the MSCe in order to place the MGW bearer A2p interface in loop back so that the BS can transmit a verification signal message (such as a tone) over the A2p interface to the MGW, which then echoes the signal back to the BS, which then quantitatively measures the verification signal message in order to verify the A2 interface continuity.

In another instantiation, the MSC may configure an A2p path for Transcoder Free Operation (TrFO). In such cases, the A2p bearer path may either pass through the MGW unaltered or pass directly between two BSs. For these cases, one BS may initiate a loop back and either the MGW or another other BS would respond to the loop back request.

In the above examples, the present invention toggles a packet-switched bearer path into and out of loop back for testing between the networks. The toggling is time-limited to prevent any noticeable interruption of service and provided a time limit for resetting the circuit to normal mode. The time limits also facilitate stable operation with systems that do no support loop back. Some of the communication operations can be performed in the background of the system so as to further reduce any noticeable interruption of service. The present invention includes new A1p/A2p procedures including new A1p messages over the A1p Interface for the purposes of bearer path verification via loop back, as will be detailed below.

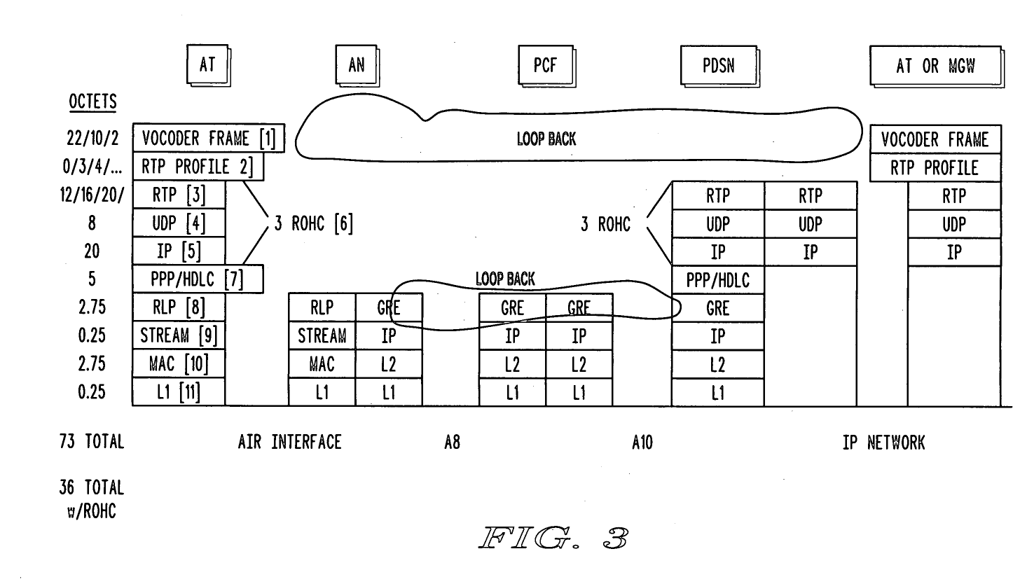

FIG. 3 shows an embodiment of FIG. 2 extended for Voice over Internet Protocol (VoIP) bearer path verification over High Rate Packet Data (HRPD) protocol stacks using signaling loop back for Internet Protocol (IP) packet-based transport protocols. In particular, a loop back mode can be utilized to verify a (VoIP) bearer path for communications between two access terminals AT (e.g. MS) or between an access terminal AT and an MGW. VoIP calls are set up using Session Initiation Protocol (SIP) and Session Description Protocols (SDP) to pass parameters that contain a vocoder profile. The present invention can add attributes to SIP messages that indicate Loop Back Request, Loop Back Request Acknowledge, Loop Back Disconnect, and Loop Back Disconnect Acknowledge.

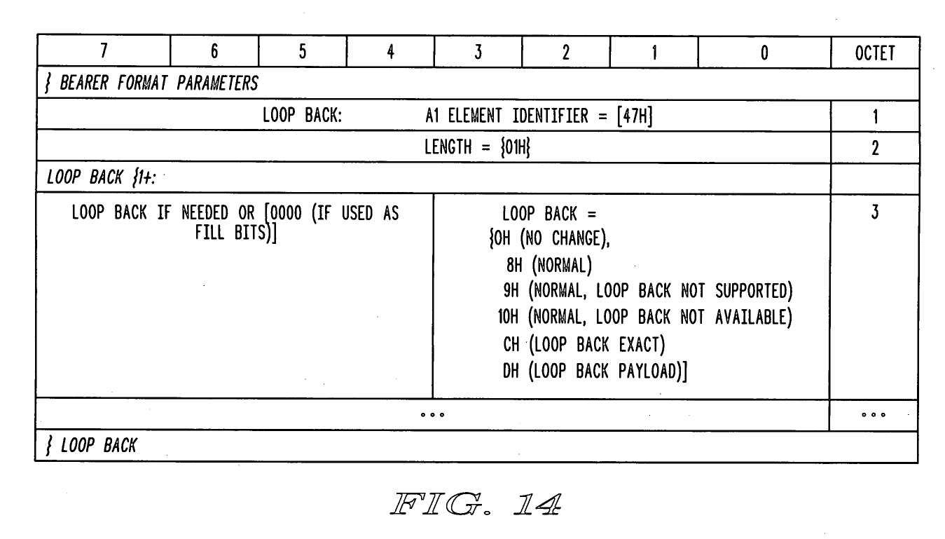

The bearer path test can be performed for one or both of an A8/A10 bearer path of an (e.g., Real-Time Protocol (RTP)) IP bearer path session layer between an access network (AN) and packet data serving node (PDSN) and an Air Interface/A8/A10/IP network bearer path of an RTP payload layer between an AT-AT(MGW). In the latter, an AT communicates with an AT or MGW over a vocoder frame control interface to ensure that packets are properly addressed to provide a loop back mode (as previously described) in the Air Interface/A8/A10/IP network bearer path. One solution is to use SIP messages with SDP syntax and add additional parameters (e.g. attributes) to perform the equivalent of the loop back messages. A Loop Back Request Acknowledge equivalent might be accomplished via a SIP 200 OK message. The Loop Back Disconnect and Loop Back Disconnect Acknowledge messages (see FIG. 14) could also map to SIP messages. In the former A8/A10 bearer path case, the AN communicates with a PDSN over a control interface to ensure that packets are properly addressed to provide a loop back mode (as previously described) in the A8/A10 bearer path; in this case, a loop back at the Generic Route Encapsulation (GRE) level between the PDSN and AN. The packet data message in the interoperability specification (IOS) would be augmented with the Loop Back information element (IE) in a manner similar to the A1 and A1p messages of FIGS. 1 and 2. As before, the loop back can be instantiated at either end of the loop with the remaining end of the loop in control of the communication path verification test.

Also as before, the present invention toggles a packet-switched IP protocol bearer path into and out of loop back for testing between the networks. The toggling is time-limited to prevent any noticeable interruption of service, and communication operations can be performed simultaneously with bearer path verification so as to minimize any noticeable delay of service during call establishment. The present invention includes new procedures for handling RTP packets over the respective interfaces for the purposes of bearer path verification via loop back.

The present invention can be utilized as part of a call origination or call termination procedures. In addition, communication path verification can be performed periodically during bearer path call handling time intervals when a bearer path is idle (i.e. there is no call). Further, the present invention takes into account those situations were communication path verification can not be performed or are not supported by the BS or RAN, wherein the present invention provides a procedure to continue packet call setup, and provides new cause codes for “Loop Back not supported” and/or “Loop Back unavailable” messages. In addition, the present invention takes into account failures of the bearer path verification, wherein enhanced call clearing procedures are implemented to tear down a call. For example, when the MSC detects circuit-switched bearer path verification failure, then the MSC will initiate call clearing. When the MSC detects the BS cannot support Loop Back or is unable to place the Circuit Identity Code (CIC) (i.e. circuit number) into Loop Back, then the MSC will continue with call setup without performing bearer path verification. The Loop Back Request Acknowledge indicates whether the requested loop back is supported. As a refinement, the Loop back acknowledge message may indicate whether loop back is not supported or whether loop back is not available. Similarly, when the MSCe detects packet data bearer path verification failure, then the MSCe will initiate call clearing. When the MSCe detects the BS cannot support Loop Back or is unable to place the RTP session into Loop Back, then the MSCe will continue with call setup without performing bearer path verification. The BS indicates whether or not loop back is supported in the Loop Back Request Acknowledge message.

In accordance with the preferred embodiment of the invention, the period of time for bearer path verification could be very short, e.g., a few tenths of a second, which is at least one order of magnitude shorter than the default period set for the dormant timer used within the radio access network for other purposes. The specific values of timers are normally adjusted for a deployment. Moreover, several timers can be provided for different timing aspects of the present invention, as will be detailed below. Further, instructions for multiple bearer path verifications can be provided in one command sequence, or commands can be provided for bearer path verification on a path-by-path basis. More detailed examples of communication path verification, in accordance with the present invention, are provided below.

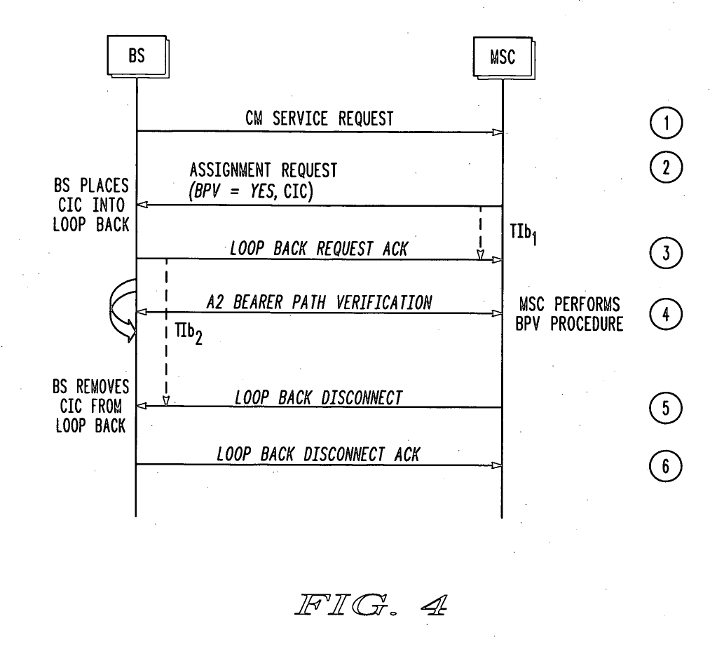

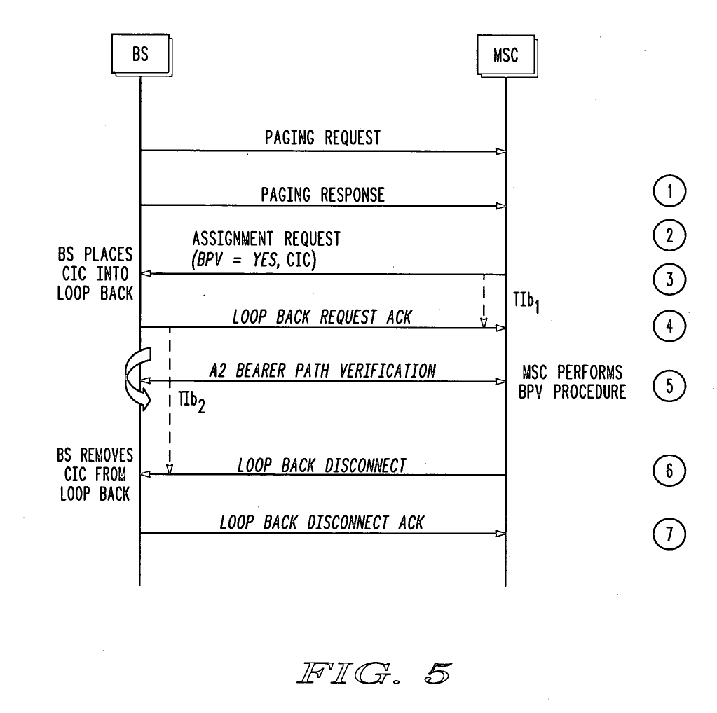

FIG. 4 shows a call flow diagram of a mobile originating call via a circuit-switched MSC. In step 1, the BS constructs a connection management (CM) Service Request message, places it in the Complete Layer 3 Information message, and sends the message to the circuit-switched MSC on the A1 interface.

In step 2, the circuit-switched MSC sends an Assignment Request message (see FIG. 14) to the BS to request assignment of radio resources on the A1 interface. This message includes information on the terrestrial circuit (identified by a CIC), which is to be used between the circuit-switched MSC and the BS. If the MSC chooses bearer path verification (BPV), which might also be called the Loop Back Feature, for the A2 interface during call origination, the Assignment Request message includes a loop back request (BPV=Yes) for a specific circuit (CIC) on the A1 interface and the MSC starts timer Tlb1. If timer Tlb1 expires, the MSC may assume that the BS does not support the bearer path verification feature and that the circuit is in normal mode. Timer Tlb1 might expire, if the Assignment Request message is sent to a BS, such as an old BS, that does not recognize the Loop Back IE.

In step 3, if a loop back was requested in the Assignment Request message and the BS supports loop back, the BS places the designated channel (CIC) into Loop Back mode, sends a Loop Back Request Acknowledge message, with the Loop Back information element (IE) indicating which channel is in loop back mode, on the A1 interface to the MSC, and starts time Tlb2. If at any point timer Tlb2 expires, the BS returns the circuit that is in loop back mode to normal mode. If the BS does not support loop back on the requested circuit, the BS sends a Loop Back Request Acknowledge message with an indication that specified circuit is in normal mode (i.e. the loop back request is denied).

In step 4, the bearer path verification (BPV) procedure is performed wherein the MSC sends a verification signal on the A2 interface to the BS, which then echoes the signal over the A2 interface back to the MSC, which then quantitatively measures the verification signal in order to verify the A2 interface continuity. The verification signal typically includes a tone. However, it should be recognized that the verification signal can be of any type of signal or information, including normal messages or information exclusively for verification.

In step 5, if the MSC is finished with the loop back test, the MSC sends a Loop Back Disconnect message to the BS over the A1 interface, whereupon the BS returns the specified circuit to normal mode and stops timer Tlb2.

In step 6, if the BS receives a Loop Back Disconnect message, the BS sends a Loop Back Disconnect Acknowledge message to the MSC with an indication that the specified circuit is now in normal mode.

Steps 3, 5 and 6 can be performed as a background function, for example while other call setup messages are being sent between the BS and MS.

FIG. 5 shows a call flow diagram of a mobile terminating call via a circuit-switched MSC. In step 1, the circuit-switched MSC sends the Paging Request message on the A1 interface to the BS to initiate a mobile terminated call setup scenario.

In step 2, the BS constructs the Paging Response message, places it in the Complete Layer 3. Information message, and sends the message to the circuit-switched MSC on the A1 interface.

In step 3, the circuit-switched MSC sends an Assignment Request message to the BS to request assignment of radio resources on the A1 interface. This message includes information on the terrestrial circuit (CIC), if one is to be used between the circuit-switched MSC and the BS. If the MSC chooses to verify the bearer path (BPV) of the A2 interface during call termination, the Assignment Request message includes a loop back request (BPV=Yes) for a specific circuit (CIC) on the A1 interface and the MSC starts timer Tlb1. If timer Tlb1 expires, the MSC may assume that the BS does not support the bearer path verification feature and that the circuit is in normal mode.

In step 4, if a loop back was requested in the Assignment Request message and the BS supports loop back, the BS places the designated channel (CIC) into Loop Back mode, sends a Loop Back Request Acknowledge message on the A1 interface to the MSC, and starts time Tlb2. If at any point timer Tlb2 expires, the BS returns the circuit that is in loop back mode to normal mode. If the BS does not support loop back on the requested circuit, the BS sends a Loop Back Request Acknowledge message with an indication that specified circuit is in normal mode (i.e. the loop back request is denied).

In step 5, the bearer path verification (BPV) procedure is performed wherein the MSC sends a verification signal on the A2 interface to the BS, which then echoes the signal over the A2 interface back to the MSC, which then quantitatively measures the verification signal in order to verify the A2 interface continuity. The verification signal typically includes a tone. However, it should be recognized that the verification signal can be of any type of signal or information, including normal messages or information exclusively for verification.

In step 6, if the MSC is finished with the loop back test, the MSC sends a Loop Back Disconnect message to the BS over the A1 interface, whereupon the BS returns the specified circuit to normal mode and stops timer Tlb2.

In step 7, if the BS receives a Loop Back Disconnect message, the BS sends a Loop Back Disconnect Acknowledge message to the MSC with an indication that the specified circuit is now in normal mode.

Steps 4, 6 and 7 can be performed as a background function.

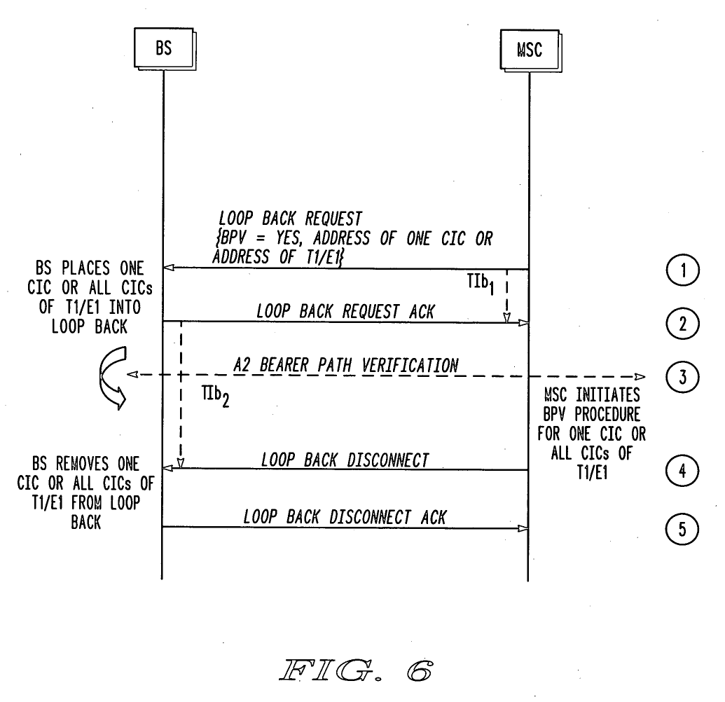

FIG. 6 shows a call flow diagram during an idle period, i.e. a period of time not associated with a call, of a circuit-switched MSC. In step 1, the circuit-switched MSC can choose to verify the bearer path (BPV) of one or more bearer paths by first sending an Loop Back Request message to the BS to request assignment of radio resources on the A1 interface. This message includes information on the address of one terrestrial circuit (CIC) or the address of a T1/E1 circuit desired to be tested. If the MSC chooses to verify the bearer path (BPV) of the indicated line, the Loop Back Request message includes a loop back request (BPV=Yes) for the specific circuit (CIC) or all CICs of the T1/E1 circuit and the MSC starts timer Tlb1 for each circuit being tested. If any timer Tlb1 expires, the MSC may assume that the indicated path does not support the bearer path verification feature and that the circuit is in normal mode.

In step 2, if a loop back was request in the Assignment Request message and the path to be tested supports loop back, the BS places the designated channel (CIC) or the CICs of the T1/E1 circuit into Loop Back mode, sends a Loop Back Request Acknowledge message on the A1 interface to the MSC, and starts time Tlb2 for each channel. If at any point timer Tlb2 expires, the BS returns the circuit that is in loop back mode to normal mode. If Loop Back mode is not supported on the requested circuit, the BS sends a Loop Back Request Acknowledge message with an indication that specified circuit is in normal mode (i.e. the loop back request is denied).

In step 3, the bearer path verification (BPV) procedure is performed wherein the MSC initiates the BPV procedure, wherein the two ends of the bearer path exchange CIC information specifying which circuit endpoint to place in Loop Back. Once the originating and terminating endpoints are defined, the originating endpoint sends a verification signal on the designated circuit(s) to a terminating endpoint, wherein the terminating endpoint network echoes the signal back to the originating endpoint, which then quantitatively measures the verification signal in order to verify the continuity of the designated circuit(s). The verification signal typically includes a tone. However, it should be recognized that the verification signal can be of any type of signal or information, including normal messages or information exclusively for verification.

In step 4, if the BPV procedure is finished, the MSC sends a Loop Back Disconnect message to the BS over the A1 interface, whereupon the BS returns the specified circuit(s) to normal mode and stops timer Tlb2. Continuous loop back mode can be accomplished by repeating the loop back request before timer Tlb2 expires.

In step 5, if the BS receives a Loop Back Disconnect message, the BS sends a Loop Back Disconnect Acknowledge message to the MSC with an indication that the specified circuit(s) is now in normal mode.

Steps 2, 4 and 5 can be performed as a background function.

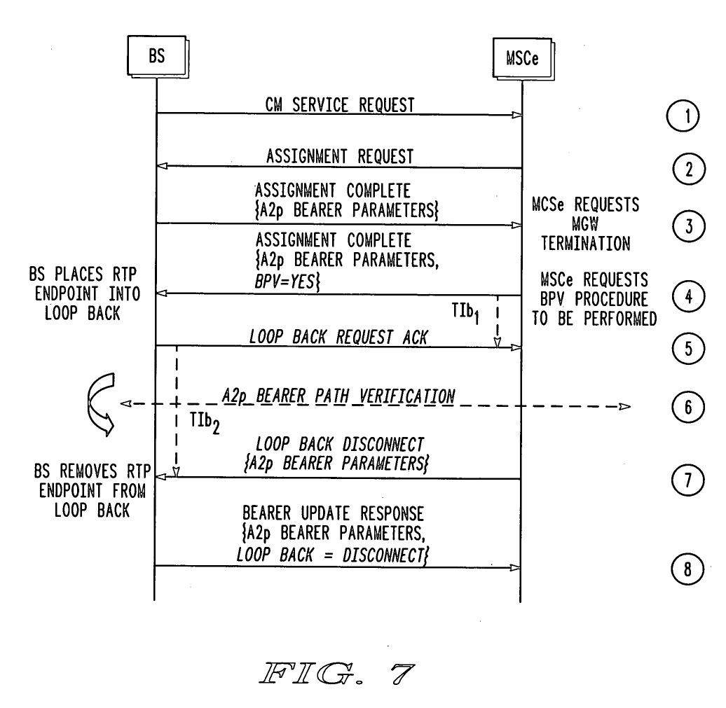

FIG. 7 shows a first call flow diagram of a mobile originating call via a packet-switched MSCe. In step 1, the BS constructs a connection management (CM) Service Request message, places it in the Complete Layer 3 Information message, and sends the message to the MSCe on the A1p interface. In this scenario, the BS does not have enough information to include the A2p bearer parameters in the CM Service Request message. Bearer parameters include packet location and address information so that the bearer packets can be routed correctly at each endpoint of the connection.

In step 2, the MSCe sends an Assignment Request message to the BS to request assignment of radio resources on the A1p interface.

In step 3, after the radio traffic channel has been established, the BS sends the Assignment Complete message to the MSCe. The A2p bearer parameters shall be included in this message, whereupon the MSCe requests a Media Gateway (MGW) termination.

In step 4, if the MSCe chooses to verify the bearer path (BPV) of the A2p interface during call origination, a Bearer Update Request message with the Loop Back IE (see FIG. 14) is sent to the BS on the A1p interface that includes a loop back request (BPV=Yes) along with the designated A2p bearer parameters, and the MSCe starts one or more instance of timer Tlb1. Note that the Bearer Update Request message may have several bearer paths and each Bearer Path would have a corresponding field in the Loop Back IE to indicated whether or not loop back is requested. An instance of Tlb1 is started for each bearer path in which loop back is requested. If an instance of timer Tlb1 expires, the MSC may assume that the BS does not support the bearer path verification feature for the associated bearer path and that the path is in normal mode.

In step 5, if a loop back was request in the Bearer Update Request message and the BS supports loop back, the BS places the designated RTP endpoint from the bearer parameters into Loop Back mode, sends a Loop Back Request Acknowledge message on the A1p interface to the MSCe, and starts one or more instances of timer Tlb2. An instance of Tlb2 is started for each bearer path that is in loop back mode. If an instance of timer Tlb2 expires, the BS returns the channel that is in loop back mode to normal mode. If the BS does not support loop back on the A2p interface, the BS sends a Loop Back Request Acknowledge message with an indication that the A2p interface is in normal mode (i.e. the loop back request is denied).

In step 6, the bearer path verification (BPV) procedure is performed wherein the MSCe initiates the BPV procedure, wherein the MGW and RTP endpoint of the bearer path exchange bearer parameter information specifying the packets to place in Loop Back. The MGW sends a verification signal with an ingress address to the RTP endpoint, wherein the RTP endpoint network echoes the signal back to the MGW with an egress address, wherein the MGW quantitatively measures the verification signal in order to verify the continuity of the designated channel. The verification signal typically includes a tone bearer. However, it should be recognized that the verification signal can be of any type of signal or information, including normal messages, headers, addresses, or information exclusively for verification.

In step 7, if the verification test is complete, the MSCe sends a Loop Back Disconnect message to the BS over the A1p interface containing the A2p bearer parameters, whereupon the BS removes the RTP endpoint from Loop Back mode and stops timer Tlb2.

In step 8, the BS sends a Bearer Update Response message to the MSCe. The loop back disconnect acknowledgement may be integrated with the Bearer Updated Response message or may be communicated by a separate message such as Loop Back Disconnect Acknowledge.

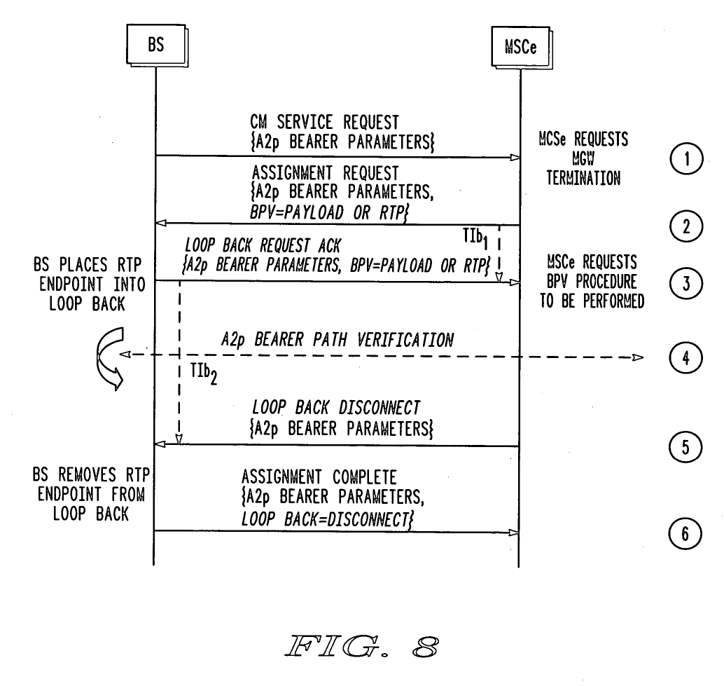

FIG. 8 shows a second call flow diagram of a mobile originating call via a packet-switched MSCe. In step 1, the BS constructs a connection management (CM) Service Request message, places it in the Complete Layer 3 Information message, and sends the message to the MSCe on the A1p interface. In this scenario, the BS has enough information to include the A2p bearer parameters in the CM Service Request message, whereupon the MSCe requests a Media Gateway (MGW) termination. Bearer parameters include packet location and address information so that the bearer packets can be routed correctly at each endpoint of the connection.

In step 2, the MSCe sends an Assignment Request message with the Loop Back E (see FIG. 14) to the BS to request assignment of radio resources on the A1p interface. The A2p bearer parameters shall be included in this message. If the MSCe chooses to verify the bearer path (BPV) of the A2p interface during call origination, a Loop Back Request is included in the message, and the MSCe starts one or more instance of timer Tlb1. Note that the Assignment Request message may have several bearer paths and each Bearer Path would have a corresponding field in the Loop Back IE to indicated whether or not loop back is requested. An instance of Tlb1 is started for each bearer path in which loop back is requested. The Loop Back Request also designates whether the Loop Back testing shall be Loop Back Exact where the RTP endpoint sends the exact same verification message without modification to the header (BPV=RTP) or Loop Back Payload which is above the RTP layer and parses the verification signal to replace the header with a modified header (BPV=Payload) (see FIG. 3). If an instance of timer Tlb1 expires, the MSC may assume that the BS does not support the bearer path verification feature for the associated bearer path and that the path is in normal mode.

In step 3, if a loop back was requested in the Assignment Request message and loop back testing is supported, the BS places the designated RTP endpoint (identified from the received bearer parameters) into Loop Back mode, sends a Loop Back Request Acknowledge message on the A1p interface to the MSCe, and starts one or more instances of timer Tlb2. An instance of Tlb2 is started for each bearer path that is in loop back mode. If an instance of timer Tlb2 expires, the BS returns the channel that is in loop back mode to normal mode. If the BS does not support loop back on the A2p interface, the BS sends a Loop Back Request Acknowledge message with an indication that the A2p interface is in normal mode (i.e. the loop back request is denied). The Loop Back Request Acknowledgment includes the A2p bearer parameters and the indication of the type of BPV test designated.

In step 4, the bearer path verification (BPV) procedure is performed wherein the MSCe initiates the BPV procedure. The MSCe and BS exchange bearer path parameter information in order to specify the packets to place in Loop Back. The MGW sends a verification signal with an ingress address to the RTP endpoint, wherein the RTP endpoint network echoes the signal back to the MGW with an egress address, wherein the MGW quantitatively measures the verification signal in order to verify the continuity of the designated channel. The verification signal typically includes a tone bearer. However, it should be recognized that the verification signal can be of any type of signal or information, including normal messages, headers, addresses, or information exclusively for verification.

In step 5, if the verification test is complete, the MSCe sends a Loop Back Disconnect message to the BS over the A1p interface containing the A2p bearer parameters, whereupon the BS removes the RTP endpoint from Loop Back mode and stops timer Tlb2.

In step 6, if the BS receives a Loop Back Disconnect message, the BS sends a Assignment Complete message to the MSCe, conveying any changes in bearer or session address configuration for the call, along with a message indicating that the Loop Back mode has been disconnected. Alternatively, the loop back disconnect acknowledgement may be communicated with a separate message such as a Loop Back Disconnect Acknowledge. In either case, the Loop Back IE (as shown in FIG. 14) explicitly indicates which bearer path is returned to normal mode and which path may still be in loop back mode.

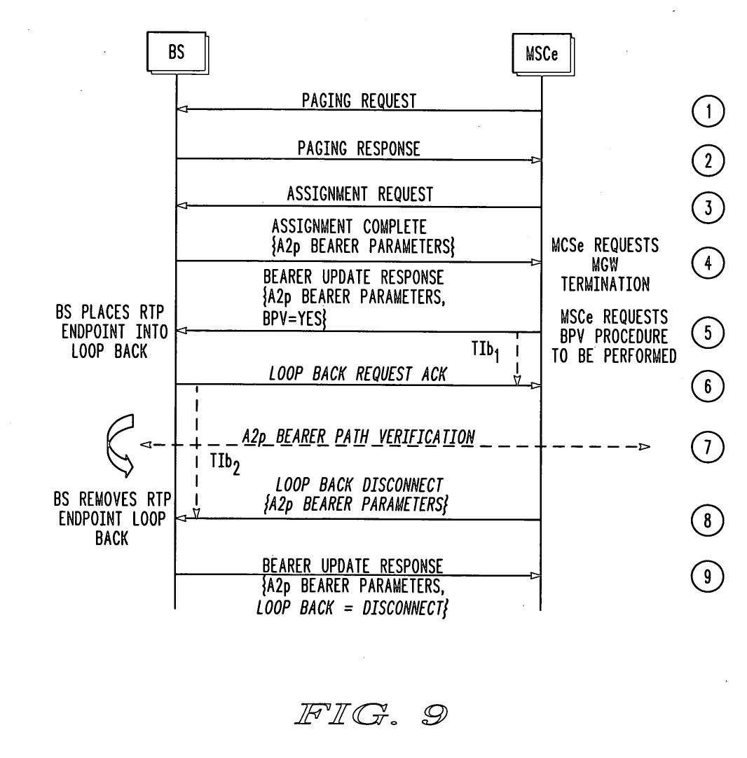

FIG. 9 shows a first call flow diagram of a mobile terminating call via a packet-switched MSCe. In step 1, the MSCe determines that an incoming call terminates to an MS within its serving region and sends the Paging Request message on the A1p interface to the BS to initiate a mobile terminated call setup scenario. The Paging Request message may include one or more A2p bearer formats.

In step 2, the BS constructs the Paging Response message, places it in the Complete Layer 3 Information message, and sends the message to the MSCe on the A1p interface. In this scenario, the BS does not have enough information to include the A2p bearer parameters in the Paging Response message. Bearer parameters include packet location and address information so that the bearer packets can be routed correctly at each endpoint of the connection.

In step 3, the MSCe sends an Assignment Request message to the BS to request assignment of radio resources on the A1p interface.

In step 4, after the radio traffic channel has been established, the BS sends the Assignment Complete message to the MSCe. The A2p bearer parameters shall be included in this message, whereupon the MSCe requests a Media Gateway (MGW) termination.

In step 5, if the MSCe chooses to verify the bearer path (BPV) of the A2p interface during call termination, a Bearer Update Request message with the Loop Back IE (see FIG. 14) is sent to the BS on the A1p interface that includes a loop back request (BPV=Yes) along with the designated A2p bearer parameters, and the MSCe starts one or more instance of timer Tlb1. Note that the Bearer Update Request message may have several bearer paths and each Bearer Path would have a corresponding field in the Loop Back IE to indicate whether or not loop back is requested. An instance of Tlb1 is started for each bearer path in which loop back is requested. If an instance of timer Tlb1 expires, the MSC may assume that the BS does not support the bearer path verification feature for the associated bearer path and that the path is in normal mode.

In step 6, if a loop back was requested in the Bearer Update Request message and the BS supports loop back, the BS places the designated RTP endpoint from the bearer parameters into Loop Back mode, sends a Loop Back Request Acknowledge message on the A1p interface to the MSCe, and starts time Tlb2. If at any point timer Tlb2 expires, the BS returns the channel that is in loop back mode to normal mode. If the BS does not support loop back on the A2p interface, the BS sends a Loop Back Request Acknowledge message with an indication that the A2p interface is in normal mode (i.e. the loop back request is denied).

In step 7, the bearer path verification (BPV) procedure is performed wherein the MSCe initiates the BPV procedure, wherein the MGW and RTP endpoint of the bearer path exchange bearer parameter information specifying the packets to place in Loop Back. The MGW sends a verification signal with an ingress address to the RTP endpoint, wherein the RTP endpoint network echoes the signal back to the MGW with an egress address, wherein the MGW quantitatively measures the verification signal in order to verify the continuity of the designated channel. The verification signal typically includes a tone bearer. However, it should be recognized that the verification signal can be of any type of signal or information, including normal messages, headers, addresses, or information exclusively for verification.

In step 8, if the verification test is complete, the MSCe sends a Loop Back Disconnect message to the BS over the A1p interface containing the A2p bearer parameters, whereupon the BS removes the RTP endpoint from Loop Back mode and stops timer Tlb2.

In step 9, the BS sends a Bearer Update Response message to the MSCe, conveying any changes in bearer or session address configuration for the call. The BS may include the Loop Back IE or alternatively, may send a separate message to acknowledge the a loop back disconnect. In either case, the Loop Back IE (FIG. 14) explicitly indicates which bearer path is returned to normal mode and which path may still be in loop back mode.

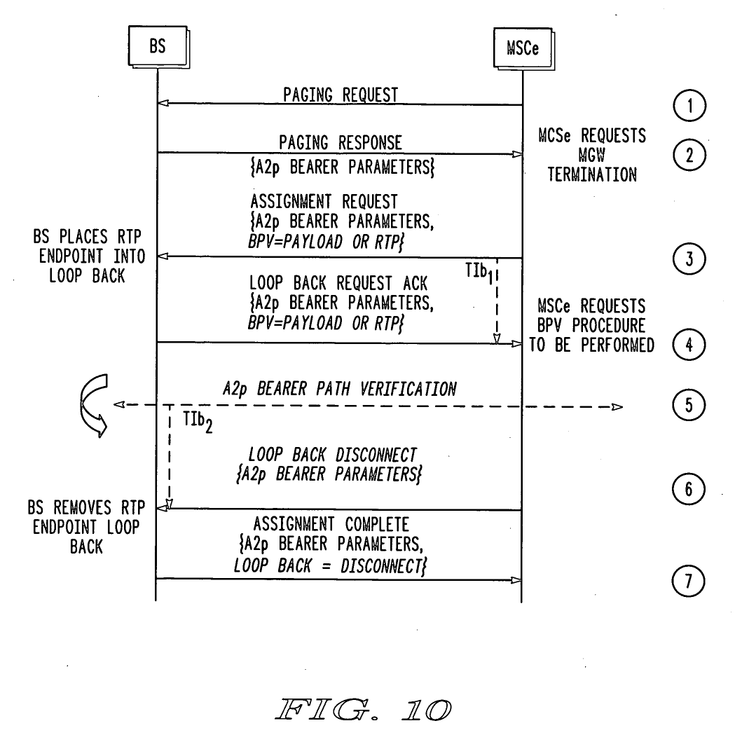

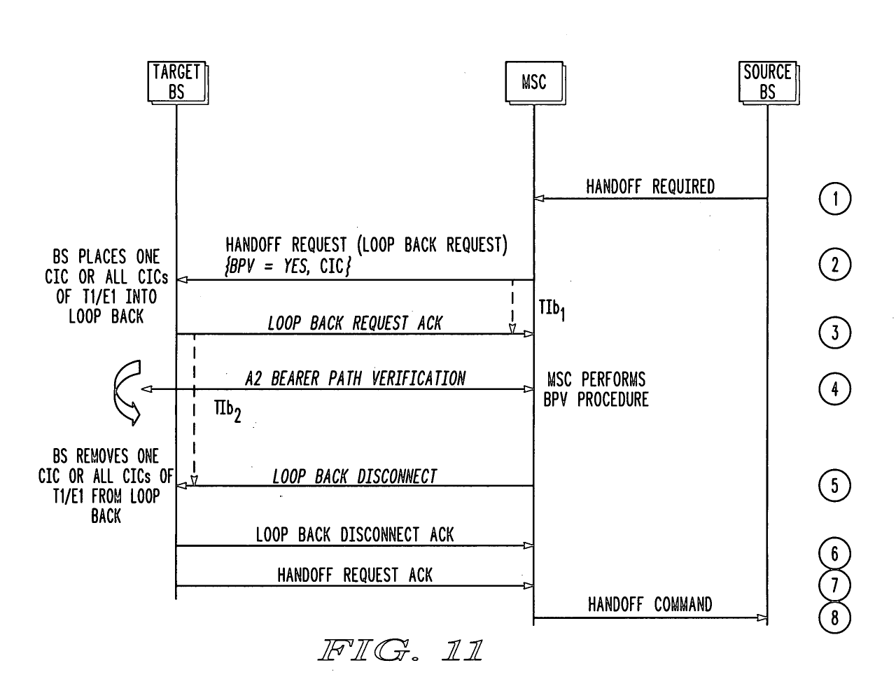

FIG. 10 shows a second call flow diagram of a mobile terminating call via a packet-switched MSCe. In step 1, the MSCe determines that an incoming call terminates to an MS within its serving region and sends the Paging Request message on the A1p interface to the BS to initiate a mobile terminated call setup scenario. The Paging Request message may include one or more A2p bearer formats.

In step 2, the BS constructs the Paging Response message, places it in the Complete Layer 3 Information message, and sends the message to the MSCe on the A1p interface. In this scenario, the BS has enough information to include the A2p bearer parameters in the CM Service Request message, whereupon the MSCe requests a Media Gateway (MGW) termination. Bearer parameters include packet location and address information so that the bearer packets can be routed correctly at each endpoint of the connection.

In step 3, the MSCe sends an Assignment Request message with the Loop Back IE to the BS to request assignment of radio resources on the A1p interface. The A2p bearer parameters shall be included in this message. If the MSCe chooses to verify the bearer path (BPV) of the A2p interface during call termination, a Loop Back Request is included in the message, and the MSCe starts one or more instance of timer Tlb1. Note that the Assignment Request message may have several bearer paths and each Bearer Path would have a corresponding field in the Loop Back IE to indicated whether or not loop back is requested. An instance of Tlb1 is started for each bearer path in which loop back is requested. The Loop Back Request also designates whether the Loop Back testing shall be Loop Back Exact where the RTP endpoint sends the exact same verification message with the header includes (BPV=RTP) or Loop Back Payload which is above the RTP layer and parses the verification signal to replace the header with a modified header (BPV=Payload) (see FIG. 3). If an instance of timer Tlb1 expires, the MSC may assume that the BS does not support the bearer path verification feature for the associated bearer path and that the path is in normal mode.

In step 4, if a loop back was requested in the Assignment Request message and loop back testing is supported, the BS places the designated RTP endpoint from the bearer parameters into Loop Back mode, sends a Loop Back Request Acknowledge message on the A1p interface to the MSCe, and starts time Tlb2. If at any point timer Tlb2 expires, the BS returns the channel that is in loop back mode to normal mode. If the BS does not support loop back on the A2p interface, the BS sends a Loop Back Request Acknowledge message with an indication that the A2p interface is in normal mode (i.e. the loop back request is denied). The Loop Back Request Acknowledgment includes the A2p bearer parameters and the indication of the type of BPV test designated.

In step 5, the bearer path verification (BPV) procedure is performed wherein the MSCe initiates the BPV procedure, wherein the MGW and RTP endpoint of the bearer path exchange bearer parameter information specifying the packets to place in Loop Back. The MGW sends a verification signal with an ingress address to the RTP endpoint, wherein the RTP endpoint network echoes the signal back to the MGW with an egress address, wherein the MGW quantitatively measures the verification signal in order to verify the continuity of the designated channel. The verification signal typically includes a tone bearer. However, it should be recognized that the verification signal can be of any type of signal or information, including normal messages, headers, addresses, or information exclusively for verification.

In step 6, if the verification test is complete, the MSCe sends a Loop Back Disconnect message to the BS over the A1p interface containing the A2p bearer parameters, whereupon the BS removes the RTP endpoint from Loop Back mode and stops timer Tlb2.

In step 7, the BS sends an Assignment Complete message to the MSCe, conveying any changes in bearer or session address configuration for the call, along with a message indicating that the Loop Back mode has been disconnected. The loop back disconnect may be integrated with the Assignment complete message or sent via a separate Loop Back Disconnect Acknowledge message. In either case, the Loop Back IE explicitly indicates which bearer path is returned to normal mode and which path retains loop-back mode.

FIG. 11 shows a call flow diagram of a mobile call handoff between a Source BS and a Target BS via a circuit-switched MSC. In step 1, based on an MS report that it crossed a network specified threshold for signal strength or for other reasons, the Source BS recommends a handoff to one or more cells in the domain of the target BS. The Source BS sends a Handoff Required message with the list of cells to the MSC.

In step 2, the MSCe sends a Handoff Request with Loop Back IE (see FIG. 14) message to the Target BS with the IS-95 Channel Identity element or the IS-2000 Channel Identity element present, based on if the MSC proceeds with a CDMA-CDMA handoff attempt and the corresponding IS-2000 or IS-95 Channel Identity element was present in the Handoff Required message. If the MSC chooses to verify the bearer path (BPV) of the A2 interface during handoff, the Handoff Request message includes a Loop Back Request (BPV=Yes) for a specific circuit (CIC) on the A1 interface, and the MSC starts one or more instance of timer Tlb1. Note that the Assignment Request message may have several bearer paths and each Bearer Path would have a corresponding field in the Loop Back IE to indicated whether or not loop back is requested. An instance of Tlb1 is started for each bearer path in which loop back is requested. If an instance of timer Tlb1 expires, the MSC may assume that the Target BS does not support the bearer path verification feature for the associated bearer path and that the path is in normal mode.

In step 3, if a loop back was requested in the Handoff Request message and loop back testing is supported, the Target BS places the designated channel (CIC) into Loop Back mode, sends a Loop Back Request Acknowledge message on the A1 interface to the MSC, and starts time Tlb2. If at any point timer Tlb2 expires, the BS returns the circuit that is in loop back mode to normal mode. If the BS does not support loop back on the requested circuit, the BS sends a Loop Back Request Acknowledge message with an indication that specified circuit is in normal mode (i.e. the loop back request is denied).

In step 4, the bearer path verification (BPV) procedure is performed wherein the MSC sends a verification signal on the A2 interface to the target BS, which then echoes the signal over the A2 interface back to the MSC, which then quantitatively measures the verification signal in order to verify the A2 interface continuity. The verification signal typically includes a tone. However, it should be recognized that the verification signal can be of any type of signal or information, including normal messages or information exclusively for verification.

In step 5, if the verification test is complete, the MSC sends a Loop Back Disconnect message to the Target BS over the A1 interface containing, whereupon the Target BS returns the specified circuit to normal mode and stops timer Tlb2.

In step 6, if the Target BS receives a Loop Back Disconnect message, the Target BS sends a Loop Back Disconnect Acknowledge message to the MSC, with an indication that the specified circuit is now in normal mode.

In step 7, a Handoff Request Acknowledge message is also sent to the MSC containing service configuration records. Alternatively, the loop back disconnect acknowledge may be integrated with the Handoff Request Acknowledge message instead of sending an explicit Loop Back Disconnect Acknowledge message (Step 6).

In step 8, the MSC prepares to switch the MS from the Source BS to the Target BS and sends a Handoff Command message to the Source BS. The MSC shall include in the Handoff Command message the service configuration records it received in the Handoff Request Acknowledge message.

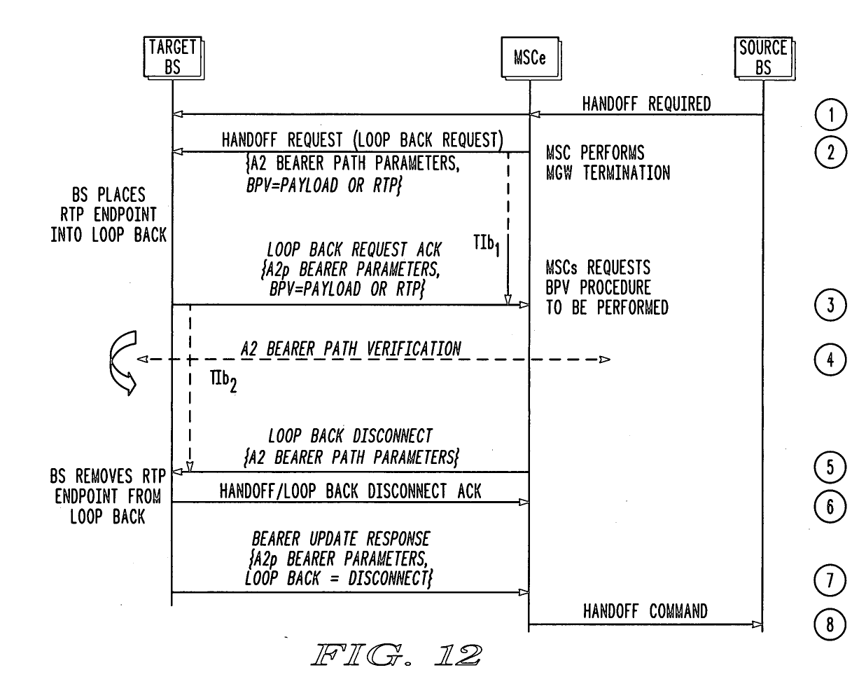

FIG. 12 shows a call flow diagram of a mobile call handoff between a Source BS and a Target BS via a packet-switched MSCe. In step 1, based on an MS report that it crossed a network specified threshold for signal strength or for other reasons, the Source BS recommends a handoff to one or more cells in the domain of the target BS. The Source BS sends a Handoff Required message with the list of cells to the MSCe.

In step 2, the MSCe sends a Handoff Request or Bearer Update Request message with the Loop Back IE to the Target BS with the IS-95 Channel Identity element or the IS-2000 Channel Identity element present, based on if the MSCe proceeds with a CDMA-CDMA handoff attempt and the corresponding IS-2000 or IS-95 Channel Identity element was present in the Handoff Required message. The Handoff Request or Bearer Update Request message with the Loop Back IE (see FIG. 14) may also include the A2p bearer parameters, containing the MGW address. Bearer parameters include packet location and address information so that the bearer packets can be routed correctly at each endpoint of the connection. If the MSCe chooses to verify the bearer path (BPV) of the A2p interface during handoff, the Handoff Request or Bearer Update Request message includes a Loop Back Request for a specific circuit or bearer path, and the MSCe starts one or more instance of timer Tlb1. Note that the Bearer Update Request message may have several bearer paths and each Bearer Path would have a corresponding field in the Loop Back IE to indicated whether or not loop back is requested. An instance of Tlb1 is started for each bearer path in which loop back is requested. The A2p bearer parameters shall be included in this message. The Loop Back Request can also designate whether the Loop Back testing shall be Loop Back Exact where the RTP endpoint sends the exact same verification message with the header includes (BPV=RTP) or Loop Back Payload which is above the RTP layer and parses the verification signal to replace the header with a modified header (BPV=Payload) (see FIG. 3). If an instance of timer Tlb1 expires, the MSCe may assume that the Target BS does not support the bearer path verification feature for the associated bearer path and that the path is in normal mode.

In step 3, if a loop back was requested in the Handoff Request or Bearer Update Request message and loop back testing is supported, the Target BS places the designated RTP endpoint from the bearer parameters into Loop Back mode, sends a Loop Back Request Acknowledge message on the A1p interface to the MSCe, and starts one or more instances of timer Tlb2. An instance of Tlb2 is started for each bearer path that is in loop back mode. If an instance of timer Tlb2 expires, the Target BS returns the channel that is in loop back mode to normal mode. If the Target BS does not support loop back on the A2p interface, the Target BS sends a Loop Back Request Acknowledge message with an indication that the A2p interface is in normal mode (i.e. the loop back request is denied). The Loop Back Request Acknowledgment includes the A2p bearer parameters and the indication of the type of BPV test designated.

In step 4, the bearer path verification (BPV) procedure is performed wherein the MSCe initiates the BPV procedure, wherein the MGW and RTP endpoint of the bearer path exchange bearer parameter information specifying the packets to place in Loop Back. The MGW sends a verification signal with an ingress address to the RTP endpoint, wherein the RTP endpoint network echoes the signal back to the MGW with an egress address, wherein the MGW quantitatively measures the verification signal in order to verify the continuity of the designated channel. The verification signal typically includes a tone bearer. However, it should be recognized that the verification signal can be of any type of signal or information, including normal messages, headers, addresses, or information exclusively for verification.

In step 5, if the verification test is complete, the MSCe sends a Loop Back Disconnect message to the Target BS over the A1p interface containing the A2p bearer parameters, whereupon the Target BS removes the RTP endpoint from Loop Back mode and stops timer Tlb2.

In step 6, if the Target BS receives a Loop Back Disconnect message, the Target BS sends a Loop Back Disconnect Acknowledge message to the MSCe, with an indication that the specified bearer path is now in normal mode. A Handoff Request Acknowledge message is also sent to the MSCe containing service configuration records.

In step 7, the Target BS sends a Bearer Update Response message to the MSCe, conveying any changes in bearer or session address configuration for the call.

In step 8, the MSCe prepares to switch the MS from the Source BS to the Target BS and sends a Handoff Command message to the Source BS. The MSCe shall include in the Handoff Command message the service configuration records it received in the Handoff Request Acknowledge message.

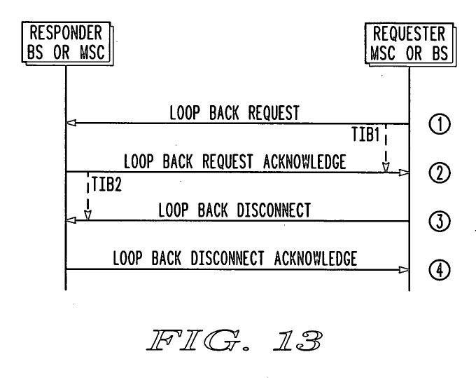

The above examples show an MSC requesting loop back and a BS providing loop back. However, it should be recognized that the reverse situation is also valid for the present invention. An example of such situation is represented in FIG. 13 shows a call flow diagram during an idle period, i.e. a period of time not associated with a call,

In step 1, the loop back requester sends a Loop Back Request message to the loop back responder indicating a circuit or bearer paths that are to be placed in loop back mode. This message includes an additional Loop Back information element (IE) to specify the Loop Back request. The loop back request applies the bearer paths identified by the A2p bearer parameters IEs in the order the bearer paths appear in this message. The requester starts an instance of timer Tlb1 for each circuit or bearer path in the loop back request. If an instance of timer Tlb1 expires, the loop back requester may assume that the responder does not support the bearer path verification feature for the requested circuit or bearer path and that the circuit or bearer path is in normal mode. If the responder can support loop back, the responder places the requested circuit or bearer paths in loop back mode at the responder's end of the circuit or bearer path.

In step 2, if the responder supports loop back, the responder sends a Loop Back Acknowledge message to the requester indicating which circuit or bearer paths are in loop back mode and starts one or more instances of timer Tlb2. An instance of Tlb2 is started for each bearer path that is in loop back mode. If an instance of timer Tlb2 expires, the responder returns the circuit or bearer paths that are in loop back mode to normal mode. If the responder does not support loop back on the requested circuit, the responder sends a Loop Back Acknowledge message with an indication that specified circuit or bearer paths are in normal mode (i.e. the loop back request is denied). Upon receipt of the Loop Back Acknowledge message, the loop back requester may send a test signal on the bearer path that is in loop back mode, as described previously.

In step 3, if the requester is finished with the loop back test, the requester sends a Loop Back Disconnect message to the responder. The responder returns the specified circuit to normal mode and stops timer Tlb2. Continuous loop back mode can be accomplished by repeating the loop back request before timer Tlb2 expires.

In step 4, if the responder receives a Loop Back Disconnect message, the responder sends a Loop Back Disconnect Acknowledge message to the requester with an indication that the specified circuit is in normal mode.

FIG. 14 shows and example coding of the information element used in the loop back related messages. FIG. 14 shows a binary coding, but a character oriented version could also be used. Other codings for the information element can be accomplished. The Loop Back E communicates one or more instances of a circuit or bearer path that is to be placed in loop back or disconnected from loop back depending on which message contains the loop back IE. As more circuits or paths are included the length parameter is increased accordingly. Within the loop back field, a null value, a normal value and one or more loop back values are communicated. In the example code, codes are assigned for loop back exact and loop back payload. If, for example, a Loop Back Request message asked for loop back exact, a corresponding Loop Back Acknowledge may respond with a loop back exact as a positive acknowledgement. Alternatively, the Loop Back Acknowledge message may response with a normal indication as a negative acknowledgement. As defined herein, loop back exact would echo the frame including any unaltered header information and loop back payload would return the payload of the frame with potentially modified header and checksum. The normal codes could be further refined as “cause codes” to indicate “loop back not supported” and “loop back unavailable”

In those situations were communication path verification can not be performed or are not supported by the networks, the present invention provides a procedure to continue call setup, and provide new cause codes for “Loop Back not supported” and/or “Loop Back unavailable” messages. In addition, the present invention takes into account failures of the bearer path verification, wherein enhanced call clearing procedures are implemented to tear down a call. For example, when the MSC detects circuit-switched bearer path verification failure, then the MSC will initiate call clearing. When the MSC detects the BS cannot support Loop Back or is unable to place the CIC (i.e. circuit number) into Loop Back, then the MSC will continue with call setup without performing bearer path verification. New cause codes are added for “Loop Back not supported” and/or “Loop Back unavailable”. Similarly, when the MSCe detects packet data bearer path verification failure, then the MSCe will initiate call clearing. When the MSCe detects the BS cannot support Loop Back or is unable to place the RTP session into Loop Back, then the MSCe will continue with call setup without performing bearer path verification. New cause codes are added for “Loop Back not supported” and/or “Loop Back unavailable.”

While the invention may be susceptible to various modifications and alternative forms, a specific embodiment has been shown by way of example in the drawings and has been described in detail herein. However, it should be understood that the invention is not intended to be limited to the particular forms disclosed. Rather, the invention is to cover all modification, equivalents and alternatives falling within the spirit and scope of the invention as defined by the following appended claims

While the present invention has been particularly shown and described with reference to particular embodiments thereof, it will be understood by those skilled in the art that various changes may be made and equivalents substituted for elements thereof without departing from the broad scope of the invention. In addition, many modifications may be made to adapt a particular situation or material to the teachings of the invention without departing from the essential scope thereof. Therefore, it is intended that the invention not be limited to the particular embodiments disclosed herein, but that the invention will include all embodiments falling within the scope of the appended claims.

What is claimed is:

1. In a communication system infrastructure, a method of verification of a communication path between a first and a second network the method comprising the steps of:
requesting verification of a communication path by the first network;
acknowledging the verification request by the second network;
placing the communication path in a loop back mode by the second network;
sending a verification signal over the communication path by the first network;
returning the verification signal over the communication path by the second network; and
terminating the loop back mode by the second network.

2. The method of claim 1, wherein the communication path is a bearer path.

3. The method of claim 1, wherein the communication path is a bearer path between a radio access network and a mobile switching core network.

4. The method of claim 1, wherein the communication path is a bearer path of one of the group of a circuit-switch communication or a packet data communication.

5. The method of claim 1, wherein the verification signal is an audio tone.

6. The method of claim 1, wherein the method can occur during at least one of the group of: during a call setup, during a call termination, and during an idle period within a call.

7. The method of claim 1, wherein the requesting and acknowledging steps occur on a control interface channel and the sending and returning steps occur on the communication channel.

8. The method of claim 1, wherein if the acknowledging step is not provided within a predetermined time limit from the requesting step, the method is terminated.

9. In a communication system infrastructure, a method of verification of a bearer path between a first and a second network, the method comprising the steps of:
requesting verification of the bearer path by the first network on a control interface channel;
acknowledging the verification request by the second network on the control interface channel;
placing the bearer path in a loop back mode by the second network;
sending a verification signal over the bearer path by the first network;
returning the verification signal over the bearer path by the second network;
verifying that the verification signal was returned over the bearer path by the first network; and
terminating the loop back mode by the second network within a predetermined time period after the acknowledging step.

10. The method of claim 9, wherein the control interface channel and bearer path are one of the group of A1/A2 interfaces for circuit-switched communications and A1p/A2p interfaces for packet communications.

11. The method of claim 9, further comprising the step of providing channel parameters by the first network, wherein the channel parameters can include one of the group of a channel identifier for a circuit-switched communication and bearer parameters for a packet communication.

12. The method of claim 11, wherein the bearer parameters include at least one of the group of an internet address and an internet real-time protocol endpoint.

13. The method of claim 9, wherein if the acknowledging step is not provided within a predetermined time limit from the requesting step, the method is terminated.

14. The method of claim 9, wherein the first and second networks include respective communication nodes that can be any one of the group of: two mobile switching centers, a base station to a mobile switching center, and a mobile switching center to a base station respectively.

15. A communication system infrastructure including a first and second network with a control interface and bearer path therebetween, wherein the communication system provides verification of the bearer path, the system comprising:
a verification request sent by the first network on the control interface to the second network;
an acknowledgment of the verification request sent by the second network on the control interface to the first network;
a verification signal sent over the bearer path by the first network; and
a loop back mode used to echo the verification signal back to the first network by the second network on the bearer path for verification, the loop back mode having a timer to ensure that the loop back mode is only in effect temporarily, wherein the second network initiates and terminates the loop back mode within a predetermined time period after the acknowledgment of the verification request.

16. The system of claim 15, wherein the control interface and bearer path are one of the group of A1/A2 interfaces for circuit-switched communications and A1p/A2p interfaces for packet communications.

17. The system of claim 15, further comprising channel parameters provided by the first network, wherein the channel parameters can include one of the group of a channel identifier for a circuit-switched communication and bearer parameters for a packet communication.

18. The system of claim 17, wherein the bearer parameters include at least one of the group of an internet address and an internet real-time protocol endpoint.

19. The system of claim 15, wherein if the verification request acknowledgement is not provided within a predetermined time limit from the verification requesting then verification is terminated.

20. The system of claim 15, wherein the first and second networks include respective communication nodes that can be any one of the group of: two mobile switching centers, a base station to a mobile switching center, and a mobile switching center to a base station, respectively.
